(19) United States
(12) Patent Application Publication
(10) Pub. No.: US 2017/0298560 A1
(43) Pub. Date: Oct. 19, 2017

(54) Washing Machine Appliance with On Demand Fluid Additive

(71) Applicant: General Electric Company, Schenectady, NY (US)

(72) Inventor: Alexander B. Leibman, Prospect, KY (US)

(21) Appl. No.: 15/132,384

(22) Filed: Apr. 19, 2016

(51) Int. Cl. D06F 39/02; G06F 3/02; D06F 39/08; D06F 21/08; D06F 39/00; D06F 33/02; G06F 3/0488; D06F 39/14

(52) U.S. Cl. CPC D06F 39/022; G06F 3/0488; G06F 3/02; D06F 39/14; D06F 21/08; D06F 39/005; D06F 33/02; D06F 39/088

(57) ABSTRACT

A washing machine appliance includes a reservoir and a dispensing assembly having a Venturi pump, a supply conduit and a water valve. The Venturi pump is coupled to the supply conduit such that the Venturi pump draws fluid additive from the reservoir when the water valve is open and water flows through the Venturi pump. A controller opens the water valve in response to actuation of a user input.

### FIELD OF THE INVENTION

The present subject matter relates generally to washing machine appliances, such as vertical axis washing machine appliances.

### BACKGROUND OF THE INVENTION

Washing machine appliances generally include a tub for containing water or wash liquid, e.g., water and detergent, bleach, and/or other wash additives. A basket is rotatably mounted within the tub and defines a wash chamber for receipt of articles for washing. During normal operation of such washing machine appliances, the wash liquid is directed into the tub and onto articles within the wash chamber of the basket. The basket or an agitation element can rotate at various speeds to agitate articles within the wash chamber, to wring wash fluid from articles within the wash chamber, etc.

During operation of certain washing machine appliances, a volume of wash liquid is directed into the tub in order to wash and/or rinse articles within the wash chamber. One or more fluid additives may be added to the wash liquid to enhance the cleaning or other properties of the wash liquid. The fluid additives may be in powder or concentrated liquid form, and are generally added to a dispenser box of the washing machine appliance by, e.g., a user of the washing machine appliance. The dispenser box may contain various chambers for containing different additives, e.g., wash detergent and softener. Water may be directed into the chambers of the dispenser box through a plurality of water inlet valves to mix with the additives and the resulting wash liquid is then dispensed into the wash chamber.

The volume of water or wash liquid needed may vary depending upon a variety of factors. For example, large loads can require a large volume of water relative to small loads that can require a small volume of water. A user may wish to have additional wash liquid dispensed in order to perform a specific task, e.g., prewash an article of clothing or add additional liquid to accommodate an extra-large load. The ability to adjust the amount of water or wash liquid dispensed is a generally commercially desirable feature and increases the user's positive perception of the wash process generally. However, conventional washing machine appliances typically do not have water-on-demand features, and those that do require additional nozzles, hoses, clamps, and other hardware to perform such a function.

Accordingly, a washing machine appliance that provides a user with more control over the water or wash liquid fill amount is desirable. In particular, a dispenser box having a simple, convenient, integrated system for dispensing an additional predetermined amount of wash liquid would be particularly beneficial.

### BRIEF DESCRIPTION OF THE INVENTION

The present subject matter provides a washing machine appliance with a reservoir and a dispensing assembly having a Venturi pump, a supply conduit and a water valve. The Venturi pump is coupled to the supply conduit such that the Venturi pump draws fluid additive from the reservoir when the water valve is open and water flows through the Venturi pump. A controller opens the water valve in response to actuation of a user input. Additional aspects and advantages of the invention will be set forth in part in the following description, or may be apparent from the description, or may be learned through practice of the invention.

In a first exemplary embodiment, a washing machine appliance is provided. The washing machine appliance includes a cabinet having a top panel. The top panel of the cabinet defines an opening. A tub is disposed within the cabinet below the top panel. A basket is rotatably mounted within the tub. A reservoir is positioned below the top panel. An inlet of the reservoir is positioned at the opening of the top panel. A dispensing assembly is mounted to the top panel. The dispensing assembly includes a Venturi pump, a supply conduit and a water valve. The supply conduit extends between the reservoir and the Venturi pump. An exit of the Venturi pump is positioned proximate the tub. The Venturi pump is coupled to the supply conduit such that the Venturi pump draws fluid additive from the reservoir when the water valve is open and water flows through the Venturi pump. The washing machine appliance also includes a user input. A controller is in operative communication with the user input and the water valve. The controller opens the water valve in response to actuation of the user input.

In a second exemplary embodiment, a vertical axis washing machine appliance is provided. The vertical axis washing machine appliance includes a cabinet having a top panel. A tub is disposed within the cabinet below the top panel. A basket is rotatable about a substantially vertical axis within the tub. A reservoir is positioned below the top panel. A dispensing assembly is positioned at the top panel. The dispensing assembly includes a Venturi pump, a supply conduit and a water valve. The supply conduit extends between the reservoir and the Venturi pump. The Venturi pump coupled to the supply conduit such that the Venturi pump draws fluid additive from the reservoir when the water valve is open and water flows through the Venturi pump. A user input is positioned on the top panel. A controller is in operative communication with the user input and the water valve. The controller opens the water valve in response to actuation of the user input.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to an exemplary embodiment of the present subject matter with a door of the exemplary washing machine appliance shown in a closed position.

FIG. 2 provides a perspective view of the exemplary washing machine appliance of FIG. 1 with the door shown in an open position.

FIG. 3 provides a front, perspective view of an exemplary dispenser box assembly installed in the exemplary washing machine appliance of FIG. 1.

FIG. 4 provides a front, perspective view of the exemplary dispenser box assembly of FIG. 3.

FIG. 5 provides a rear, perspective view of the exemplary dispenser box assembly of FIG. 3.

FIG. 6 provides a schematic view of certain components of the exemplary washing machine appliance of FIG. 1.

FIG. 7 provides a perspective view of a reservoir of the exemplary washing machine appliance of FIG. 1 fluidly coupled to the exemplary dispenser box assembly of FIG. 3.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

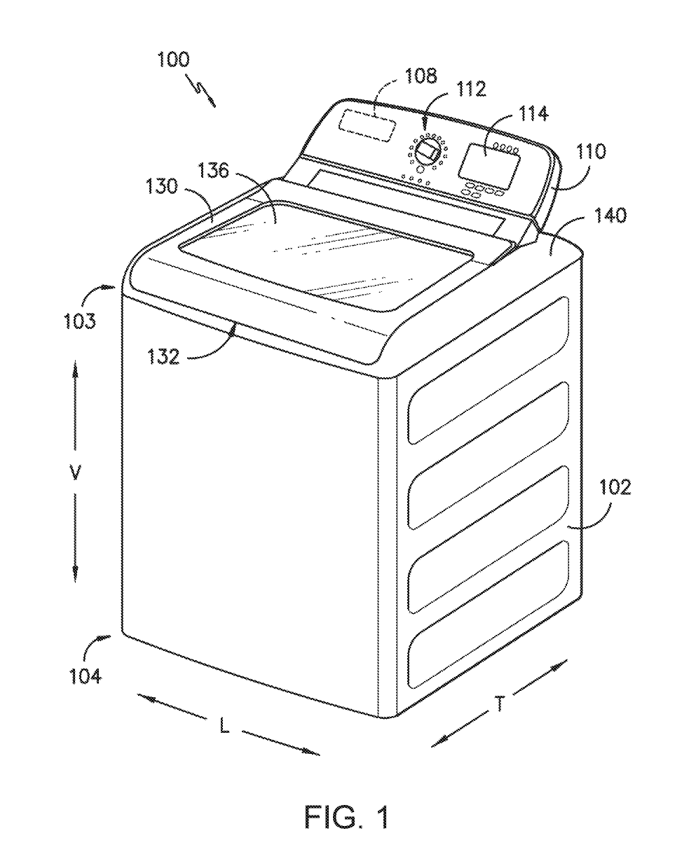

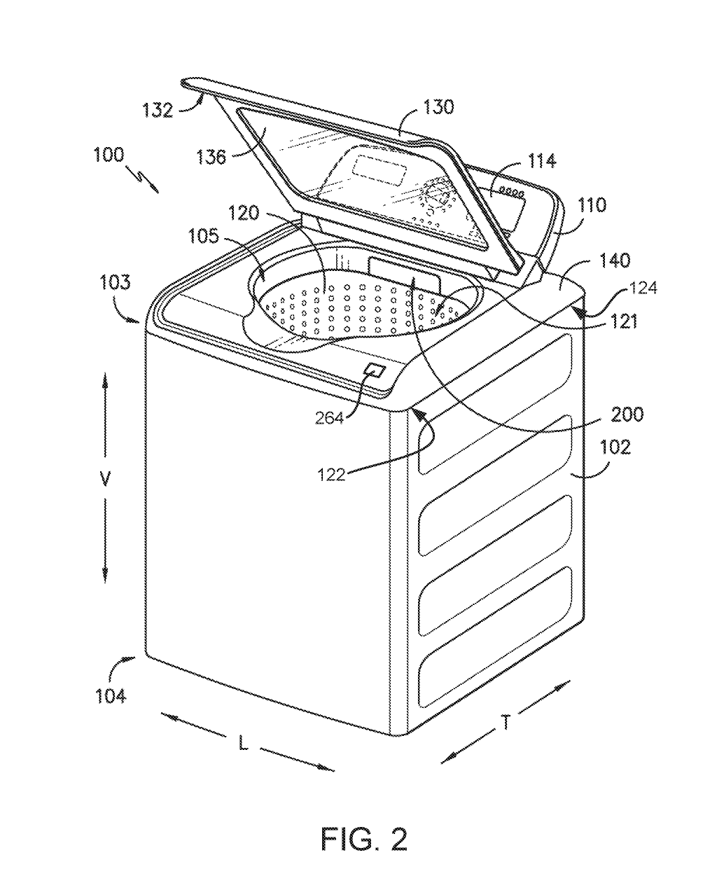

FIGS. 1 and 2 illustrate an exemplary embodiment of a vertical axis washing machine appliance 100. In FIG. 1, a lid or door 130 is shown in a closed position. In FIG. 2, door 130 is shown in an open position. Washing machine appliance 100 generally defines a vertical direction V, a lateral direction L, and a transverse direction T, which are mutually perpendicular with one another, such that an orthogonal coordinate system is generally defined.

While described in the context of a specific embodiment of vertical axis washing machine appliance 100, using the teachings disclosed herein it will be understood that vertical axis washing machine appliance 100 is provided by way of example only. Other washing machine appliances having different configurations, different appearances, and/or different features may also be utilized with the present subject matter as well, e.g., horizontal axis washing machines.

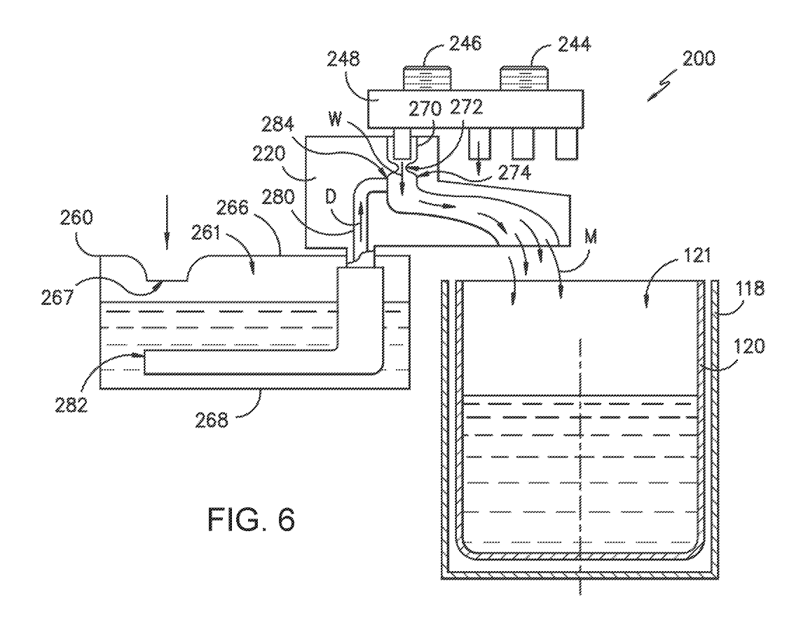

Washing machine appliance 100 has a cabinet 102 that extends between a top portion 103 and a bottom portion 104 along the vertical direction V. A wash tub 118 (FIG. 6) is disposed within cabinet 102, and a wash basket 120 is rotatably mounted within tub 118. A motor (not shown) is in mechanical communication with wash basket 120 to selectively rotate wash basket 120 (e.g., during an agitation or a rinse cycle of washing machine appliance 100). Wash basket 120 defines a wash chamber 121 that is configured for receipt of articles for washing. Tub 118 holds wash and rinse fluids for agitation in wash basket 120 within tub 118. An agitator or impeller (not shown) extends into wash basket 120 and is also in mechanical communication with the motor. The impeller assists agitation of articles disposed within wash basket 120 during operation of washing machine appliance 100.

Cabinet 102 of washing machine appliance 100 has a top panel 140, e.g., at top portion 103 of cabinet 102. Top panel 140 defines an aperture 105 that permits user access to wash basket 120 of tub 118. Door 130, rotatably mounted to top panel 140, permits selective access to aperture 105; in particular, door 130 selectively rotates between the closed position shown in FIG. 1 and the open position shown in FIG. 2. In the closed position, door 130 inhibits access to wash basket 120. Conversely, in the open position, a user can access wash basket 120. A window 136 in door 130 permits viewing of wash basket 120 when door 130 is in the closed position, e.g., during operation of washing machine appliance 100. Door 130 also includes a handle 132 that, e.g., a user may pull and/or lift when opening and closing door 130. Further, although door 130 is illustrated as mounted to top panel 140, alternatively, door 130 may be mounted to cabinet 102 or any other suitable support.

Top panel 140 also defines a hole or opening 142, e.g., at a corner of top panel 140 at or adjacent a front portion 122 of top panel 140 as shown in FIG. 2. Opening 142 is configured for receipt of one of a plurality of fluid additives, e.g., detergent, fabric softener, and/or bleach. Opening 142 permits the fluid additive to pass through top panel 140 to a reservoir 260 (FIG. 6) disposed below top panel 140 along the vertical direction V. Thus, a user may pour the fluid additive into reservoir 260 through opening 142 in top panel 140. Reservoir 260 is described in greater detail below.

A control panel 110 with at least one input selector 112 extends from top panel 140, e.g., at a rear portion 124 of cabinet 102 opposite opening 142 about aperture 105 along the transverse direction T. Control panel 110 and input selector 112 collectively form a user interface input for operator selection of machine cycles and features. A display 114 of control panel 110 indicates selected features, operation mode, a countdown timer, and/or other items of interest to appliance users regarding operation.

Operation of washing machine appliance 100 is controlled by a controller or processing device 108 that is operatively coupled to control panel 110 for user manipulation to select washing machine cycles and features. In response to user manipulation of control panel 110, controller 108 operates the various components of washing machine appliance 100 to execute selected machine cycles and features.

Controller 108 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 100 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 110 and other components of washing machine appliance 100 may be in communication with controller 108 via one or more signal lines or shared communication busses.

During operation of washing machine appliance 100, laundry items are loaded into wash basket 120 through aperture 105, and washing operation is initiated through operator manipulation of input selectors 112. Tub 118 is filled with water and detergent and/or other fluid additives via dispenser box assembly 200, which will be described in detail below. One or more valves can be controlled by washing machine appliance 100 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with an impeller as discussed previously) for washing of laundry items in wash basket 120.

After the agitation phase of the wash cycle is completed, wash basket 120 can be drained. Laundry articles can then be rinsed by again adding fluid to wash basket 120 depending on the specifics of the cleaning cycle selected by a user. The impeller may again provide agitation within wash basket 120. One or more spin cycles also may be used. In particular, a spin cycle may be applied after the wash cycle and/or after the rinse cycle to wring wash fluid from the articles being washed. During a spin cycle, wash basket 120 is rotated at relatively high speeds. After articles disposed in wash basket 120 are cleaned and/or washed, the user can remove the articles from wash basket 120, e.g., by reaching into wash basket 120 through aperture 105.

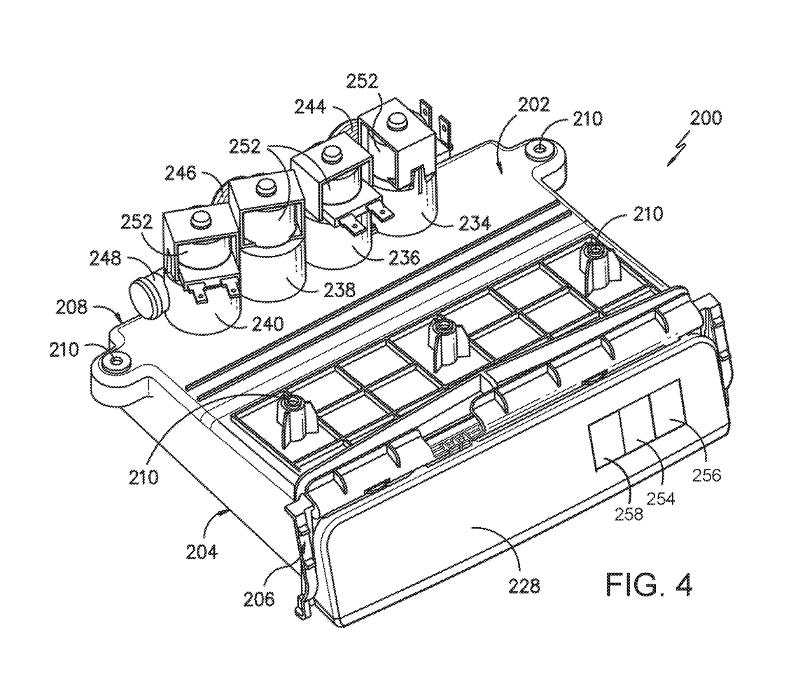

Referring now generally to FIGS. 2 through 5, dispenser box assembly 200 will be described in more detail. Although described in greater detail below in the context of washing machine appliance 100, it will be understood that dispenser box assembly 200 may be used in or with any other suitable washing machine appliance, in alternative exemplary embodiments. In addition, other configurations of dispenser box assembly 200 may be provided as well. For example, dispenser box assembly 200 may be positioned on a front of cabinet 102, may have a different shape or chamber configuration, and may dispense water, detergent, or other additives. Other variations and modifications of the exemplary embodiment described below are possible, and such variations are contemplated as within the scope of the present subject matter.

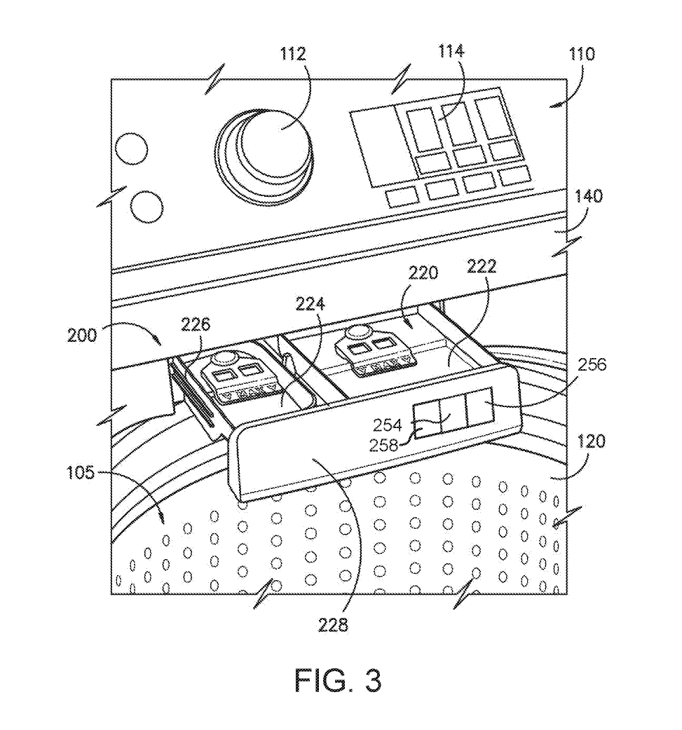

Dispenser box assembly 200 is a box having a substantially rectangular cross-section that defines a top 202 and a bottom 204, e.g., spaced apart along the vertical direction V. Dispenser box assembly 200 also defines a front side 206 and a back side 208, e.g., spaced apart along the transverse direction T. As best shown in FIGS. 2 and 3, dispenser box assembly 200 may be mounted underneath top panel 140 of cabinet 102, e.g., at rear portion 124 of cabinet 102, such that front side 206 is visible inside aperture 105. More specifically, dispenser box assembly 200 may be mounted to top panel 140 using a plurality of mounting features 210, which may, for example, be configured to receive mechanical fasteners. One skilled in the art will appreciate that dispenser box assembly 200 may be mounted in other locations and use other mounting mechanisms in alternative exemplary embodiments.

Dispenser box assembly 200 may define a mixing chamber 220 configured to receive one or more additive compartments. For example, according to the illustrated embodiment, mixing chamber 220 may be configured to slidably receive a detergent compartment 222 and a softener compartment 224. Detergent and softener compartments 222, 224 are slidably connected to the mixing chamber 220 using slides 226 and are connected to a front panel 228 of dispenser box assembly. In this manner, a user may pull on front panel 228 to slide detergent and softener compartments 222, 224 along the transverse direction T. Once extended, detergent compartment 222 and softener compartment 224 may be conveniently filled with detergent and softener, respectively. Front panel 228 may be then be pushed back into mixing chamber 220, e.g., before a wash cycle begins.

Although the illustrated embodiment shows detergent compartment 222 and softener compartment 224 slidably received in mixing chamber 220 for receiving wash additives, one skilled in the art will appreciate that different configurations are possible in alternative exemplary embodiments. For example, more compartments may be used and the compartments may be accessed by a lid instead of sliding out of mixing chamber 220. In addition, as discussed in greater detail below, mixing chamber 220 may draw wash additives from a separate storage container such that sliding compartments 222, 224 may be removed from mixing chamber 220.

Dispenser box assembly 200 may further include a plurality of valves configured to supply hot and cold water to mixing chamber 220 or directly to tub 118. For example, according to the illustrated embodiment, a plurality of apertures may be defined on top 202 of mixing chamber 220 for receiving water. Each aperture (not shown) may be in fluid communication with a different portion of the mixing chamber. A plurality of valve seats may be positioned over top of each of those apertures to receive a valve that controls the flow of water through each aperture.

For example, a first valve seat 234 may be in fluid communication with a first aperture for providing hot water into detergent compartment 222. A second valve seat 236 may be in fluid communication with a second aperture for providing cold water into detergent compartment 222. A third valve seat 238 may be in fluid communication with a third aperture for providing cold water into softener compartment 224. A fourth valve seat 240 may be in fluid communication with a fourth aperture for providing cold water into mixing chamber 220 or directly into tub 118.

Water inlets may be placed in fluid communication with each of valve seats 234, 236, 238, 240. More specifically, a hot water inlet 244 may be connected to a hot water supply line (not shown) and a cold water inlet 246 may be connected to a cold water supply line (not shown). According to the illustrated embodiment, each water inlet 244, 246 may include a threaded male adapter configured for receiving a threaded female adapter from a conventional water supply line. However, any other suitable manner of fluidly connecting a water supply line and water inlets 244, 246 may be used. For example, each water supply line and water inlets 244, 246 may have copper fittings that may be sweated together to create a permanent connection.

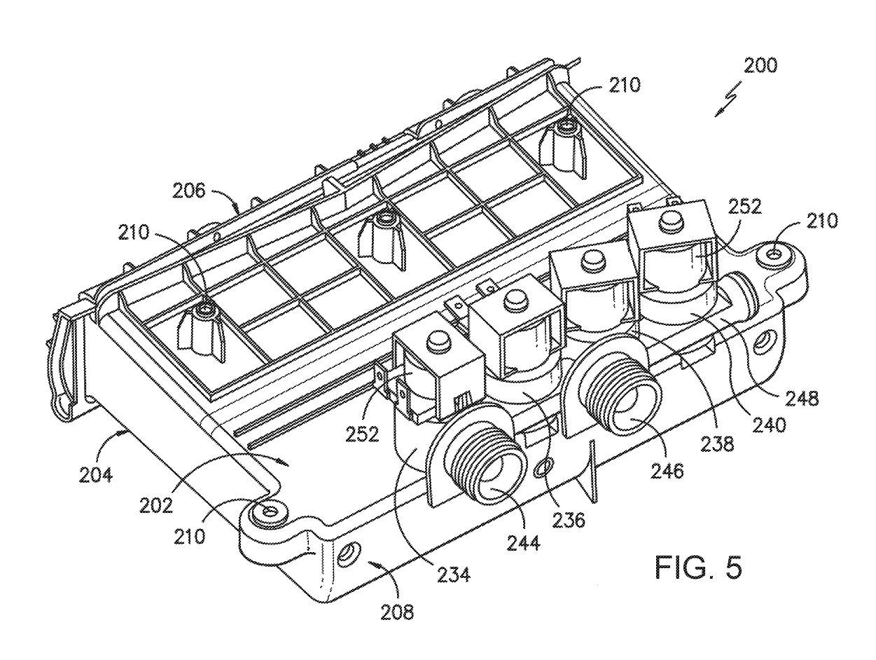

Notably, hot water inlet 244 is in direct fluid communication with first valve seat 234. However, because washing machine appliance 100 uses cold water for multiple purposes, cold water inlet 246 is in fluid communication with a cold water manifold 248. As best shown in FIG. 5, cold water manifold 248 is a cylindrical pipe that extends along the lateral direction from second valve seat 236 to fourth valve seat 240. In this manner, cold water manifold 248 places valve seats 236, 238, 240 in fluid communication with cold water inlet 246.

Each of valve seats 234, 236, 238, 240 may be configured to receive a water valve 252 for controlling the flow of water through a corresponding aperture into mixing chamber 220. Water valve 252 may be, for example, a solenoid valve that is electrically connected to controller 108. However, any other suitable water valve may be used to control the flow of water. Controller 108 may selectively open and close water valves 252 to allow water to flow from hot water inlet 244 through first valve seat 234 and from cold water manifold 248 through one or more of second valve seat 236, third valve seat 238, and fourth valve seat 240.

Dispenser box assembly 200 may also include one or more outlets (not shown) for directing wash fluid, such as water and/or a mixture of water and at least one fluid additive, e.g., detergent, fabric softener, and/or bleach into tub 118 from dispenser box assembly 200. For example, when second valve seat 236 is open, water may flow from cold water inlet 246 through cold water manifold 248 and second valve seat 236 into detergent compartment 222. Water may mix with detergent placed in detergent compartment 222 to create wash liquid to be dispensed into tub 118.

An outlet (not shown) may be positioned on the bottom of detergent compartment 222 or on the bottom of mixing chamber 220 to dispense the wash fluid into tub 118. According to the illustrated embodiment, dispenser box assembly 200 may include four outlets; each associated with a respective one of valves seats 234, 236, 238, 240. However, it will be understood that different outlet configurations may be used in alternative exemplary embodiments. For example, outlets may be positioned on a bottom of mixing chamber 220 near tub 118 or directly on tub 118, but could be positioned in other locations as well.

In some situations, a user may wish to add additional water to wash tub 121. For example, a user may wish to prewash one or more articles of clothing or may perceive that more water is needed to effectively wash a load. Accordingly, dispenser box assembly 200 may include a system for allowing a user to add water to wash tub 121 on demand, i.e., a water-on-demand feature.

In this regard, dispenser box assembly 200 may include one or more buttons that are configured to control one or more of valves 252. According to the exemplary embodiment illustrated in FIG. 3, dispenser box assembly 200 includes a cold water button 254, a hot water button 256 and a water-detergent mixture button (or fluid additive-water mixture button) 258 for controlling valves 252 on first valve seat 234, fourth valve seat 240 and second valve seat 236, respectively. However, one skilled in the art will appreciate that additional buttons may be included and the buttons may control different valves 252 or any combination of valves 252. In addition, one skilled in the art will appreciate that any of these buttons can be turned on/off independently or together in any combination.

Cold water button 254, hot water button 256 and water-detergent mixture button 258 (hereinafter also referred to as “buttons 254, 256, 258”) may be any button or switch suitable for providing an indication to controller 108 that a particular action should be initiated. For example, buttons 254, 256, 258 may be push button switches, toggle switches, rocker switches, or any other suitable tactile switch, such as capacitive touch buttons. According to the illustrated embodiments, buttons 254, 256, 258 are momentary switches (sometimes referred to as mom-off-mom switches). In this regard, buttons 254, 256, 258 are biased switches that return to their unlatched or unpressed state when released, e.g., by spring force.

According to the exemplary embodiment illustrated in FIG. 3, cold water button 254, hot water button 256 and water-detergent mixture button 258 may be located on front panel 228 of dispenser box assembly 200. According to other embodiments, buttons 254, 256, 258 may be placed in any other suitable location that is easy to access by a user. For example, as shown in FIG. 2, water-detergent mixture button 258 may be positioned on top panel 140 at front portion 122 of top panel 140 with opening 142 and opposite control panel 110 about aperture 105 along the transverse direction T. In certain exemplary embodiments, washing machine appliance 100 may include multiple water-detergent mixture buttons 258, for example, positioned at both locations, i.e., on front panel 228 of dispenser box assembly 200 and on top panel 140 at front portion 122 of top panel 140.

As illustrated for washing machine appliance 100, buttons 254, 256, 258 are all positioned in front of control panel 110. This may be advantageous because washing machine appliance 100 is a vertical axis, top load washing machine that has door 130 that pivots up, thereby blocking access to control panel 110 when door 130 is in the open position. Thus, buttons 254, 256, 258 are preferably located somewhere within wash tub 121 that is easily accessible when door 130 blocks access to control panel 110. Buttons 254, 256, 258 may also be positioned below door 130 along the vertical direction V when door 130 is closed. Thus, buttons 254, 256, 258 may be covered by door 130 when door is closed such that door 130 hinders or blocks access to buttons 254, 256, 258 and inadvertent actuation of buttons 254, 256, 258.

Notably, buttons 254, 256, 258 may be placed directly on dispenser box assembly 200 or in very close proximity to mixing chamber 220. In addition, buttons 254, 256, 258 may control valves 252 that are already included on washing machine appliance 100. This obviates the need for additional hardware required for an independent water delivery system, e.g., nozzles, high voltage circuits, mounting hardware, etc. As a result, the water-on-demand feature provides an inexpensive, reliable, simple, and intuitive system to deliver additional water to wash tub 121 when the user desires. Similarly, because valves 252 and water delivery system are integrated into an existing dispenser box assembly 200, washing machine appliance 100 may have a more aesthetically pleasing appearance.

Buttons 254, 256, 258 may be used by a user to deliver an additional amount of water to wash tub 121 on demand, e.g., during or prior to any cycle. The additional amount of water may be a specific volume of water or valves 252 may simply be opened for a specific amount of time. For example, according to an exemplary embodiment, pressing hot water button 256 will open valve 252 seated on first valve seat 234 and deliver hot water to detergent compartment 222 or mixing chamber 220 for twenty seconds. However, one skilled in the art will appreciate that water may be delivered for other time durations as controlled by the user, e.g., via settings on controller 108, or as set by the manufacturer. Indeed, these values may be set by the manufacturer, determined by controller 108 based on the operating parameters selected, selected by the consumer, or set in any other suitable manner.

One skilled in the art will appreciate that the amount of water added to wash tub 121 upon pressing buttons 254, 256, 258 may vary depending on the application or wash cycle. Similarly, the amount of water delivered may be preset (as described above) such that pressing buttons 254, 256, 258 delivers the predetermined amount of water. Alternatively, valves 252 may be configured to remain open at all times when corresponding buttons 254, 256, 258 are depressed. In this manner, a user may precisely control the amount of water added to wash tub 121. In order to ensure that wash tub 121 is never overfilled, a maximum water level sensor may be included in the wash tub 121. When water reaches the maximum level, controller 108 may automatically close all valves 252 or perform a drain cycle to prevent water from spilling out of wash tub 121.

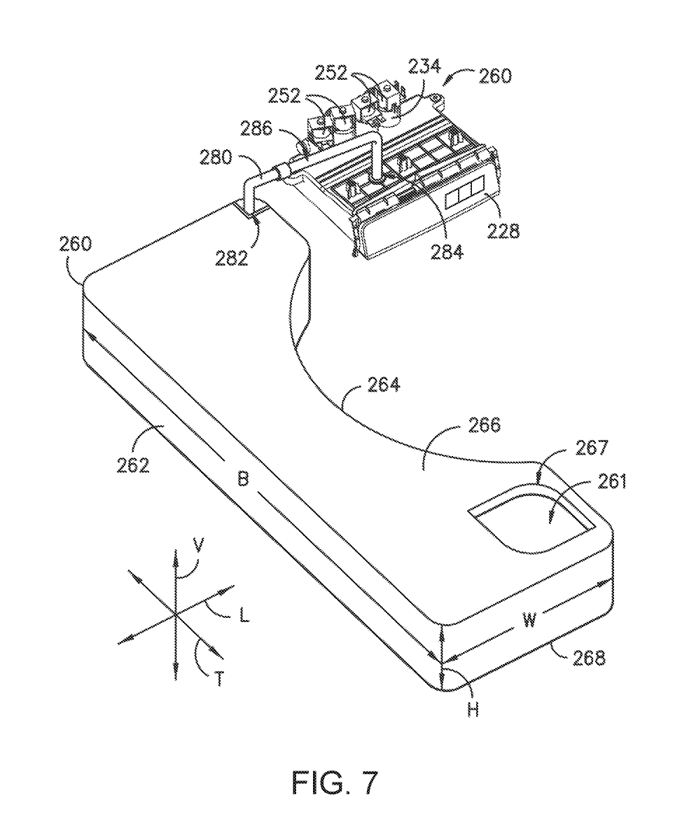

FIG. 6 provides a schematic view of certain components of washing machine appliance 100. FIG. 7 provides a perspective view of a reservoir 260 of washing machine appliance 100 fluidly coupled to dispenser box assembly 200. Although described in greater detail below in the context of washing machine appliance 100 and dispenser box assembly 200, it will be understood that reservoir 260 may be used in or with any other suitable washing machine appliance and/or without dispenser box assembly 200, in alternative exemplary embodiments. In addition, other configurations of reservoir 260 may be provided as well. For example, reservoir 260 may be positioned on a front of cabinet 102, may have a different shape or chamber configuration. Other variations and modifications of the exemplary embodiment described below are possible, and such variations are contemplated as within the scope of the present subject matter.

Reservoir 260 may be filled with detergent, and washing machine appliance 100 includes features for drawing detergent within reservoir 260 to dispenser box assembly 200. Within dispenser box assembly 200, the detergent from reservoir 260 is mixed with water and directed into tub 118 of washing machine appliance 100. Thus, reservoir 260 may contain a bulk volume of detergent (e.g., or other suitable fluid additive) such that reservoir 260 is sized for holding a volume of detergent sufficient for a plurality of wash cycles of washing machine appliance 100, such as no less than twenty wash cycles, no less than fifty wash cycles, etc. As a particular example, an internal volume 261 of reservoir 260 is configured for containing detergent therein, and the internal volume 261 of reservoir 260 may be no less than twenty fluid ounces, no less than three-quarters of a gallon or about one gallon. As used herein the term “about” means within half a gallon of the stated volume when used in the context of volumes. Thus, a user can avoid filling dispenser box assembly 200 with detergent before each operation of washing machine appliance by filling reservoir 260 with detergent.

As discussed above, reservoir 260 is positioned below top panel 140 (FIG. 2). In particular, an inlet 267 of reservoir 260 may be positioned at (e.g., directly below) opening 142 of top panel 140. Thus, a user may pour detergent into reservoir 260 via opening 142 of top panel 140 in order to load or fill reservoir 260 with detergent.

Reservoir 260 includes a planar sidewall 262, an arcuate sidewall 264, a top wall 266 and a bottom wall 268. Planar sidewall 262 and arcuate sidewall 264 or reservoir 260 are spaced apart from each other, e.g., along the lateral direction L. Top wall 266 and a bottom wall 268 of reservoir 260 are also spaced apart from each other, e.g., along the vertical direction V. Planar sidewall 262 and arcuate sidewall 264 of reservoir 260 may extend along the vertical direction V between top wall 266 and a bottom wall 268 of reservoir 260 in order to connect top wall 266 of reservoir 260 to bottom wall 268 of reservoir 260. Reservoir 260 may also include end walls (not labeled) that are spaced apart from each other, e.g., along the transverse direction T, and that extend along the vertical direction V between top wall 266 and bottom wall 268 of reservoir 260 in order to connect top wall 266 of reservoir 260 to bottom wall 268 of reservoir 260. Reservoir 260 may be formed from any suitable material, such as molded plastic.

Reservoir 260 has a height H along the vertical direction V. The height H of reservoir 260 may be defined between top wall 266 and bottom wall 268 of reservoir 260. Reservoir 260 also has a width W along the lateral direction L. The width W of reservoir 260 may be defined between planar sidewall 262 and arcuate sidewall 264 of reservoir 260 (e.g., at the portion of reservoir 260 where planar sidewall 262 and arcuate sidewall 264 of reservoir 260 are most spaced apart from each other along the lateral direction L). Reservoir 260 further has a breadth B along the transverse direction T. The breadth B of reservoir 260 may be defined between the opposing end walls of reservoir 260.

Reservoir 260 may be sized such that reservoir 260 is shorter along the vertical direction V than along the transverse direction T and/or the lateral direction L. For example, the height H of reservoir 260 may be no greater than six inches or no greater than four inches. As another example, the height H of reservoir 260 may be about four inches. As used herein, the term “about” means within half an inch of the stated height when used in the context of heights. Thus, reservoir 260 may have a small profile along the vertical direction V under top panel 140.

In contrast to the low vertical profile of reservoir 260, the width W and/or breadth B of reservoir 260 may be larger than the height H of reservoir 260. For example, the width W of reservoir 260 may be less than twelve inches and greater than six inches or less than ten inches and greater than seven inches. As another example, the width W of reservoir 260 may be about eight inches. As used herein, the term “about” means within an inch of the stated width when used in the context of widths. With respect to the breadth B of reservoir 260, as an example, the breadth B of reservoir 260 may be less than twenty-eight inches and greater than sixteen inches or less than twenty-four inches and greater than eighteen inches. As another example, the breadth B of reservoir 260 may be about twenty-four inches. As used herein, the term “about” means within three inches of the stated breadth when used in the context of breadths. Thus, reservoir 260 may have a small profile along the vertical direction V under top panel 140 while still being sized to contain a significant volume of detergent, e.g., no less than three-quarters of a gallon of detergent.

Washing machine appliance 100 includes various features for drawing detergent from reservoir 260 and directing the detergent into tub 118. For example, washing machine appliance 100 includes a Venturi pump 270 and a supply conduit 280. Supply conduit 280 extends between reservoir 260 and Venturi pump 270, and Venturi pump 270 draws detergent from reservoir 260 when a valve associated with Venturi pump 270 is open and water flows through Venturi pump 270. As an example, Venturi pump 270 may be configured to receive a flow of water F when one valve seat position of water valve 252 is opened (e.g., the water valve 252 on second valve seat 236). Thus, when one valve seat position of water valve 252 is open, the flow of water F may pass through Venturi pump 270.

As may be seen in FIG. 6, Venturi pump 270 may be disposed on or formed with dispenser box assembly 200. In alternative exemplary embodiments, Venturi pump 270 may be disposed on or formed with any other suitable component of washing machine appliance 100. Venturi pump 270 includes a converging section 272 and a diverging section 274. Converging section 272 of Venturi pump 270 is disposed upstream of diverging section 274 of Venturi pump 270 relative to the flow of water F through Venturi pump 270. As the flow of water F enters converging section 272 of Venturi pump 270, the flow of water F may increase in velocity and decrease in pressure. Conversely, as the flow of water passes from converging section 272 of Venturi pump 270 into diverging section 274 of Venturi pump 270, the flow of water F may increase in pressure and decrease in velocity.

Supply conduit 280 extends between an inlet 282 and an outlet 284, e.g., along the lateral direction L. Inlet 282 of supply conduit 280 is disposed within reservoir 260, e.g., at or adjacent bottom wall 268 of reservoir 260. Outlet 284 of supply conduit 280 is disposed at Venturi pump 270. A flow of detergent D may enter supply conduit 280 at inlet 282 of supply conduit 280, flow through supply conduit 280 to Venturi pump 270 and enter Venturi pump 270 via outlet 284 of supply conduit 280.

The change in pressure for the flow of water F through Venturi pump 270 may assist with drawing detergent from reservoir 260. For example, internal volume 161 of reservoir 260 may be exposed to or contiguous with ambient air about washing machine appliance 100 (e.g., via inlet 267 of reservoir 260), and outlet 284 of supply conduit 280 may be positioned on Venturi pump 270 (e.g., converging section 272 of Venturi pump 270 or diverging section 274 of Venturi pump 270) such that a pressure of fluid at outlet 284 of supply conduit 280 is less than the pressure of detergent within reservoir 260 at inlet 282 of supply conduit 280. Thus, Venturi pump 270 may pump the flow of detergent D from reservoir 260 to Venturi pump 270 via supply conduit 280 when the flow of water F passes through Venturi pump 270. Within Venturi pump 270, the flow of water F and the flow of detergent D mix and a mixture of water and detergent M exits Venturi pump 270 and flows into tub 118. In such a manner, detergent from reservoir 260 may be dispensed in to tub 118.

To operate Venturi pump 270 and dispense the mixture of water and detergent M, a user may actuate water-detergent mixture button 258. In response to actuation of water-detergent mixture button 258, controller 108 may open one of valves 252, e.g., valve 252 on second valve seat 236, such that the flow of water F enters Venturi pump 270 and draws the flow of detergent D from reservoir 260. Thus, to selectively dispense the mixture of water and detergent M, a user may actuate water-detergent mixture button 258. In such a manner, the user may dispense the mixture of water and detergent M on demand.

The shape, construction and location of reservoir 260 can assist with providing a very cost-effective bulk dispense system that delivers accurate fluid additive dosing, e.g., without the use of a costly pressure sensor. When Venturi pump 270 is actuated for a predetermined amount of time, the amount of fluid additive dispensed from reservoir 260 to Venturi pump 270 is essentially constant, e.g., because the priming time of Venturi pump 270 is also essentially constant, within a small but acceptable error, whatever the fill level of fluid additive within reservoir 260. For example, the priming time of Venturi pump 270 when reservoir 260 is full will be about equal to the priming time of Venturi pump 270 when reservoir 260 is almost empty due to the low vertical profile of reservoir 260. In particular, the level of fluid additive within reservoir 260 can vary by less than six inches between full and empty such that the priming time of Venturi pump 270 is similar in both circumstances.

As may be seen in FIG. 7, a middle portion 286 of supply conduit 280 between inlet and outlet 282, 284 of supply conduit 280 may be positioned above inlet and outlet 282, 284 of supply conduit 280 along the vertical direction V. In addition, top wall 266 of reservoir 260 may face and be positioned at top panel 140. Thus, supply conduit 280 may extend through top panel 140 such that middle portion 286 of supply conduit 280 between reservoir 260 and Venturi pump 270 is positioned above top panel 140 along the vertical direction V. In particular, middle portion 286 of supply conduit 280 may be positioned above top panel 140 along the vertical direction V and be disposed within control panel 110. In such a manner, supply conduit 280 may extend between reservoir 260 and Venturi pump 270.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A washing machine appliance, comprising:
a cabinet having a top panel, the top panel of the cabinet defining an opening;
a tub disposed within the cabinet below the top panel;
a basket rotatably mounted within the tub;
a reservoir positioned below the top panel, an inlet of the reservoir positioned at the opening of the top panel;
a dispensing assembly mounted to the top panel, the dispensing assembly comprising a Venturi pump, a supply conduit and a water valve, the supply conduit extending between the reservoir and the Venturi pump, an exit of the Venturi pump positioned proximate the tub, the Venturi pump coupled to the supply conduit such that the Venturi pump draws fluid additive from the reservoir when the water valve is open and water flows through the Venturi pump;
a user input; and
a controller in operative communication with the user input and the water valve, the controller opening the water valve in response to actuation of the user input.

2. The washing machine appliance of claim 1, wherein the reservoir has a height along a vertical direction, the height of the reservoir being no greater than six inches.

3. The washing machine appliance of claim 1, wherein the Venturi pump is configured for dispensing a mixture of fluid additive and water into the tub when the water valve is open and motif liquid flows through the Venturi pump.

4. The washing machine appliance of claim 1, wherein the water valve is a solenoid valve.

5. The washing machine appliance of claim 1, wherein the water valve is a fluid additive-water mixture valve and the user input is a fluid additive-water mixture user input, the washing machine further comprising:
a cold water valve configured to regulate a flow of cold water;
a cold water user input for adding supplemental cold water to the tub;
a hot water valve configured to regulate a flow of hot water;
a hot water user input for adding supplemental hot water to the tub,
wherein the controller opens the cold water valve in response to actuation of the cold water user input and the controller opens the hot water valve in response to actuation of the hot water user input.

6. The washing machine appliance of claim 1, wherein the user input is a switch, button or touch sensor.

7. The washing machine appliance of claim 1, wherein when the controller opens the water valve for a predetermined amount of time in response to actuation of the user input.

8. The washing machine appliance of claim 1, wherein the top panel extends between a front portion and a back portion, the user input is positioned on the top panel proximate the front portion of the top panel.

9. The washing machine appliance of claim 8, further comprising a door mounted to the cabinet, the user input positioned on the top panel beneath the door when the door is closed.

10. The washing machine appliance of claim 8, wherein the opening of the top panel is positioned at the front portion of the top panel.

11. A vertical axis washing machine appliance, comprising:
a cabinet having a top panel;
a tub disposed within the cabinet below the top panel;
a basket rotatable about a substantially vertical axis within the tub;
a reservoir positioned below the top panel;
a dispensing assembly positioned at the top panel, the dispensing assembly comprising a Venturi pump, a supply conduit and a water valve, the supply conduit extending between the reservoir and the Venturi pump, the Venturi pump coupled to the supply conduit such that the Venturi pump draws fluid additive from the reservoir when the water valve is open and water flows through the Venturi pump;
a user input positioned on the top panel; and
a controller in operative communication with the user input and the water valve, the controller opening the water valve in response to actuation of the user input.

12. The vertical axis washing machine appliance of claim 11, wherein the reservoir has a height along a vertical direction, the height of the reservoir being no greater than six inches, the vertical axis washing machine appliance does not include an electric pump operable to draw fluid additive from the reservoir.

13. The vertical axis washing machine appliance of claim 12, wherein the Venturi pump is configured for dispensing a mixture of fluid additive and water into the tub when the water valve is open and motif liquid flows through the Venturi pump.

14. The vertical axis washing machine appliance of claim 11, wherein the water valve is a solenoid valve.

15. The vertical axis washing machine appliance of claim 11, wherein the water valve is a fluid additive-water mixture valve and the user input is a fluid additive-water mixture user input, the washing machine further comprising:
a cold water valve configured to regulate a flow of cold water;
a cold water user input for adding supplemental cold water to the tub;
a hot water valve configured to regulate a flow of hot water;
a hot water user input for adding supplemental hot water to the tub,
wherein the controller opens the cold water valve in response to actuation of the cold water user input and the controller opens the hot water valve in response to actuation of the hot water user input.

16. The vertical axis washing machine appliance of claim 11, wherein the user input is a switch, button or touch sensor.

17. The vertical axis washing machine appliance of claim 11, wherein when the controller opens the water valve for a predetermined amount of time in response to actuation of the user input.

18. The vertical axis washing machine appliance of claim 11, wherein the top panel extends between a front portion and a back portion, the user input is positioned on the top panel at the front portion of the top panel.

19. The vertical axis washing machine appliance of claim 18, further comprising a door mounted to the cabinet, the user input positioned on the top panel beneath the door when the door is closed.

20. The vertical axis washing machine appliance of claim 19, wherein the top panel of the cabinet defines an opening, the opening of the top panel positioned at the front portion of the top panel, an inlet of the reservoir positioned at the opening of the top panel.
